(19) United States
(12) Patent Application Publication
(10) Pub. No.: US 2015/0156244 A1
(43) Pub. Date: Jun. 4, 2015

(54) Communication and/or Creation of Taste

(71) Applicant: Sivatharan Natkunanathan, Irvine, CA (US)

(72) Inventor: Sivatharan Natkunanathan, Irvine, CA (US)

(21) Appl. No.: 13/815,942

(22) Filed: Mar. 18, 2013

(51) Int. Cl. H04L 29/08

(52) U.S. Cl. CPC H04L 67/02

(57) ABSTRACT

A system or process for performance of taste, by means of, a standalone or network computer, or a phone, and/or a “taste-device” named or classified a “TASTEDEV”, or “MOBILE TASTEDEV”, is the subject of this invention. Taste information in a machine-device or taste-device, comprising an operating system, program, application, service, or platform, is communicated with means comprising of a connection to a taste-device with means comprising of a device driver, for performance of taste. The performance of taste by means of a machine-device and/or a taste-device, comprises, a user, client, user-client, host, machine-device, or taste-device, processing, storing, communication, and/or creation, of taste, by means comprising of a network.

A related invention is a mobile personal taste-device, named or classified a “MOBILE TASTEDEV”, comprising user-controls for PERFORMANCE of taste. The said device is user or client controlled for operation of said device. The said MOBILE TASTEDEV is a consumer product.

### BACKGROUND OF THE INVENTION

The idea for this invention was materialized during the days of communicating by means of, a network computer with means of e-mail, and internet phone; and a conventional, and mobile phone. A user, client, or user-client, communicates by means of a network computer comprising of the internet, elements comprising: text, hyperlink, or static image with means of a web page; text, hyperlink, or document attachment with means of an e-mail program, application, service, or platform; text with means of a text chat program, application, service, or platform; and voice or audio with means of an internet phone program, application, service, or platform. Similarly, a user, client, or user-client, communicates by means of a phone, elements of voice or audio. The said electronic means present limited elements in communication, as compared to elements naturally communicated during real-life events.

The quality of communication by means of a computer or phone is far removed from real-life events, as compared to tasting, a beverage or drink, a meal at a restaurant, or a spice mixture of a chef during making of a meal. The solution therefore, comprises enhancements in systems, and processes, for communicating elements that stimulate the human physiological senses during a real-life event. However, even when communication by means of a computer or phone is cumbersome in performance of elements perceived during real-life events, the communication system or process of this invention, presents elements in communication for the perception, comprising of real-life events, with means of the physiological senses of a user, client, or user-client.

This invention presents the communication, and creation, of “taste”, for the perception of taste by a user, client, or user-client, with means for performing of taste comprising electronic means. The word “taste”, as defined herein, comprises sweet, sour, bitter, salty, or a variation thereof. The element of taste, when communicated by means of a computer or phone, means with standalone or network communication, presents the additional element of taste in said communication.

The system or process for performance of taste, by the said means, is referred to herein as “TASTECOM”, which is new, or an enhancement, in communication and/or creation of taste. A said TASTECOM system or process, enhances, communication of taste to, and/or creation of taste in, the quality of real-life events.

The word “machine-device” as defined herein, comprises, a standalone or network computer, or a phone. A said computer comprises a device, apparatus, or machine, with means of, or by means of, an electronic controller and/or a microcontroller for performance of taste. The word “taste-device” as defined herein, comprises, a taste device, a personal taste device, or a variation thereof. The word “creation” as defined herein, comprises a mixture, or an output, of a taste ingredient, or substance, from, or on, a source of taste or “taste-source”.

The word “perform” or “performance” by means of a machine-device or a taste-device comprises processing, storing, communication, and/or creation, of taste by means of, a machine-device, a machine-device with means of a connection to a taste-device, or a taste-device.

The word “PERFORM” or “PERFORMANCE” by means of a machine-device or a taste-device comprises processing, storing, communication, and/or creation, of taste by means of, a machine-device with means of a connection to a taste-device, or a taste-device.

A TASTECOM system or process comprises of two independent systems or processes, one that comprises performing communication of taste, and the other that comprises PERFORMING creation of taste. The said systems or processes, detailed herein individually, and as an interdependent unitary whole, present the fundamentals for performance of taste, by the said means.

A standalone or network computer, or a phone, comprises PERFORMANCE of taste, with means of a connection to a taste-device, apparatus, or machine. The said taste-device, apparatus, or machine, is referred to herein as a device, namely a “TASTEDEV”. The said TASTEDEV comprises a permanent, desktop, or stationary taste-device, or a “PM-TASTEDEV”.

Another related invention presented herein, is a personal taste-device, apparatus, or machine, for performance of taste. The said personal taste-device, apparatus, or machine, is referred to herein as a device, namely, a “MOBILE TASTEDEV” when mobile, comprising within the definition a non-mobile personal taste-device, namely an “E-TASTEDEV”. A said taste-device employs a TASTECOM system or process for PERFORMANCE of taste. A said MOBILE TASTEDEV comprises presenting to a user, a mobile taste-device for PERFORMANCE of taste.

A TASTEDEV, and a MOBILE TASTEDEV, device, apparatus, or machine, for purposes of simplicity, is referred to as a TASTEDEV device, and a MOBILE TASTEDEV device, respectively. The word “taste” as defined earlier, alternatively refers to sweet, sour, bitter, salty, or a variation thereof, that is mixed, output, or created, by means of a taste-device.

### 1. INTRODUCTION

The scope of this invention is performance of taste, by means of, a machine-device comprising (1) a standalone or network computer, or (2) a phone, and/or (3) a taste-device comprising a TASTEDEV, or (4) a personal taste-device comprising a MOBILE TASTEDEV.

The system or process for performance of taste, by means of a said machine-device [(1), and (2)] and/or a taste-device [(3), and (4)], is referred to as “TASTECOM”. As defined herein, “taste information” comprises any information of taste, utilized for performance thereof, comprising user-controls on a taste-device.

### 2. DESCRIPTION OF PRIOR ART

Prior art relating to performing communication of taste by means of electronic devices, is minimal or non-existent. Some examples of prior art relating to performing creation of taste, are described herein-following.

Prior art relating to performing creation of taste, comprises, the manual or appliance making of taste, with a mixture of spices or ingredients, for a taste comprising of sweet, sour, bitter, salty, or a variation thereof. Another prior art comprises performing creation of smoke, with a flavor of taste. The most utilized, is performing creation of tasty edibles with an assortment comprising of a fruit, vegetable, or taste ingredients, by means of an appliance comprising a connection to a power supply.

Prior art that is proximate to performing creation of taste for mobile consumption, is performing creation of taste with an edible assortment for consumption comprising by infants, toddlers, or the like. Another prior art, for mobile consumption, is the performing creation of taste comprising of, canned or bottled drink, bagged food, packed edible, or the like.

Prior art that is proximate to performing creation of taste, by means of a mobile taste-device is limited, and encompasses a subset of the prior art said herein-before.

The fundamental prior art is performing creation of taste from a natural source with a flavor of taste, and designed prior art is performing creation of taste from a designed, developed, or manufactured, source with a flavor of taste comprising a taste substance, lotion, or the like.

### 3. OBJECTIVES AND ADVANTAGES

The objective of this invention is performance of taste, by means of a computer or phone machine-device and/or a taste-device. The said invention presents to a user, client, or user-client, the means necessary for communication of the element of taste, by means of a machine-device and/or a taste-device. The communication of the element of taste by the said means, enhances a communication system or process thereof, for a perception of taste by a user, client, or user-client, comprising of real-life events. It enhances a said system or process, with the additional element of taste, comprising network taste communication.

A further objective of this invention is a TASTECOM system or process for PERFORMANCE of taste, by means of a taste-device with means comprising of a connection to a machine-device. A taste-device comprises optional user-controls for manual PERFORMANCE of taste thereon or therefrom, with or without means of a connection to a machine-device, comprising co-PERFORMANCE. The said TASTECOM presents a robust taste-device for PERFORMANCE of a flavor of taste.

The objective of the related invention, namely MOBILE TASTEDEV, is in presenting to a user, a personal taste-device with means comprising user-controls for PERFORMANCE of taste. A TASTECOM system or process is employed, for PERFORMANCE of taste thereon or therefrom, comprising during user possession of said taste-device. A MOBILE TASTEDEV is travel friendly, and PERFORMS taste on a user-control setting or selection thereon. A MOBILE TASTEDEV comprises an optional feature, for a machine-device PERFORMANCE of taste, with mean of a connection thereto.

A TASTECOM system or process, comprises, an operating system, program, application, service, or platform, on a machine-device or taste-device; internal communication within, comprising for performance of taste by means of, a machine-device or taste-device; a machine-device communication to a taste-device; user-controls on a taste-device; and network communication on a machine-device or taste-device; for the performance of taste.

The utility of a TASTECOM system or process, comprises, performance of taste form, to, or on, a source of interest to a user, client, or user-client, with means of a machine-device or taste-device. A further utility of TASTECOM comprises advertising, marketing, or sale of a product, or products, comprising of a flavor of taste. The performance of network communication of taste information by means of a network machine-device, presents to a user, client, or user-client, a network TASTECOM with coverage of use comprising spanning the networked globe.

### SUMMARY OF THE INVENTION

The system or process of this invention, namely TASTECOM, comprises performance of taste by means of, a computer or phone machine-device with means comprising of a connection to a taste-device, or a taste-device with means comprising for a connection to a machine-device or taste-device.

The products of this invention comprise hardware, software, and hybrid, TASTECOM system or process parts, components, sub-systems, and systems. The said products enable said TASTECOM comprising for asynchronous and/or real-time performance of taste, by means of a machine-device and/or a taste-device.

A TASTECOM utilizes taste information inputted (“INPUT”) by means of, a user, client, user-client, host, machine-device, or taste-device; an electronic storage device; a taste sensor; receiving comprising accessing from another user, client, user-client, host, machine-device, or taste-device; or any other means; into a user, client, user-client, host, machine-device, or taste-device, for performance of taste. The said performance comprises, processing comprising customization, storing, and/or communicating, of taste information for performance of taste, with means comprising of an operating system, program, application, service, or platform, on a machine-device or taste-device.

An important aspect of this invention is communication of the additional element of taste, by means of a machine-device and/or taste-device, by means comprising of a network. The scope of this invention comprises user, client, user-client, host, machine-device, or taste-device communication, and use or applications of TASTECOM for personal, informational, social, and professional purposes.

A further aspect of this invention is in presenting new taste-devices for PERFORMANCE of taste, named or classified, a TASTEDEV comprising a PM-TASTEDEV, or a MOBILE TASTEDEV comprising an E-TASTEDEV. The said PM-TASTEDEV, and E-TASTEDEV, are described and explained herein-later.

A TASTEDEV PERFORMANCE of taste, comprises, when a machine-device communicates taste information with means of a connection thereto. A said machine-device performs communication of taste information to a TASTEDEV, for activation, deactivation, or PERFORMANCE of taste. The said TASTEDEV communication, comprises, an external communication from a machine-device and/or a manual user-control input thereinto, and internal communication therewithin, for PERFORMANCE of taste.

Similarly, a MOBILE TASTEDEV PERFORMANCE of taste comprises on a user-control setting or selection thereon. The said MOBILE TASTEDEV communication, comprises, a manual user-control input thereinto and/or an external communication from a machine-device with means of a connection thereto, and internal communication therewithin, for PERFORMANCE of taste.

A TASTECOM system or process for PERFORMANCE of taste comprises an optional taste controller, referred to herein as “TASTECNTRLR”. The said TASTECNTRLR is either external to, or integrated on, a said taste-device. An external TASTECNTRLR is a part, component, or subsystem, in the connection between a machine-device and a taste-device. An integrated TASTECNTRLR whereas, is a part, component, or subsystem, on a taste-device. The said TASTECNTRLR functions as a buffer, or a safety device, subjecting limitations on the PERFORMANCE of taste on said taste-device.

A TASTECOM system or process presents the necessary communication element, with means comprising of “taste data communication”, for performance of taste by means of a machine-device and/or taste-device. The said TASTECOM thereof, enhances communication of taste information comprising with the said means, comprising the additional element of taste.

Herein-following is a brief summary of the utility, use, and applications, of a TASTECOM system or process by means of, a standalone or network computer, a phone, and a MOBILE TASTEDEV. The utility, use, and applications, described herein are however not a limitation of a TASTECOM, nor a taste-device.

### (1) Standalone Computer:

A standalone computer machine-device, as defined herein, is a computer not connected to a network, comprising of the interne. The said standalone computer employs a TASTECOM system or process for performance of taste, with means comprising of a connection to a taste-device. The said TASTECOM on a standalone computer machine-device has use, and applications, comprising for personal, informational, social, and professional purposes.

A said use of TASTECOM is facilitated by means of an INPUT of taste information into said standalone computer, comprising to a user or client program, application, service, or platform, that processes, stores, and/or communicates, the said taste information for performance of taste.

The personal applications of TASTECOM comprise performance of taste for personal purposes, such as flavor tasting for personal pleasure, or for making beverages or food. The informational applications of TASTECOM comprise performance of taste for informational purposes, such as in advertising or marketing a product comprising of a flavor of taste. The social applications of TASTECOM comprise performance of taste for social purposes, such as a memo, greeting, document, or a memorabilia soft copy of an autobiography or interview, with associated taste information comprising for performance, comprising a creation, or output, of a hot or cold beverage, spirit, or the like. A further social application comprises, a computer game, or “image content” from a party, graduation, wedding, or the like, with associated information on taste comprising for performance. The professional applications of TASTECOM, comprise, sampling of a product, or products, comprising of a flavor of taste. A sample may comprise a flavor of taste for testing, or selection, employed in adverting, marketing, or sale, of a product comprising of a flavor of taste. An example comprises, advertising of a sample from a brewery, comprising of a flavor of taste from a selection of beer.

The other uses or applications of TASTECOM by means of a standalone computer machine-device, comprise PERFORMANCE of taste during use of a program, application, service, or platform. Another use or application comprises PERFORMANCE of taste during performing display comprising of, text, hyperlink, audio, image, or moving picture, by means of a said standalone computer. A further use or application is employing a standalone computer for PERFORMANCE of taste with means of a taste-device.

The said examples explain the utility, use, and applications of TASTECOM, overlapping in the purpose of use or application by means of, a standalone computer machine-device with means comprising of a connection to a taste-device, or a taste-device with means comprising for a connection to a said machine-device.

### (2) Network Computer:

A network computer machine-device, as defined herein, is a computer connected to a network, comprising of the intemet. The said network computer employs a TASTECOM system or process, for performance of taste with means comprising of a connection to a taste-device. The said TASTECOM on network computer machine-device has use, and applications, comprising for personal, informational, social, and professional purposes.

The taste information INPUT into, and performance of taste by means of, a network computer machine-device, is similar to that of a standalone computer machine-device, with the contrast being additional TASTECOM capabilities on a said network computer comprising for processing, storing, and/or communicating, of taste information for performance by means comprising of a network.

The use or applications of TASTECOM by means of a network computer machine-device, comprises said use or applications by means of a standalone computer machine-device, and additional use or applications facilitated by means comprising of a network. A network TASTECOM therefore, presents to a user, client, user-client, host, machine-device, or taste-device, performance of taste by means comprising of a network, comprising for personal, informational, social, and professional purposes.

A use of network TASTECOM is in user, client, user-client, host, machine-device, or taste-device, asynchronous and/or real-time performance of taste by means comprising of a wireline or wireless network, comprising taste information reception from, or transmission to, another user, client, user-client, host, machine-device, or taste-device. A pre-programmed, stored, or INPUT, taste information is utilized by a transmitting user, client, user-client, host, machine-device, or taste-device, and received by a receiving user, client, user-client, host, machine-device, or taste-device. A said network taste communication, with the additional element of taste, is employed in network TASTECOM for performance, with means comprising of an operating system, program, application, service, or platform.

The use or applications of said network TASTECOM, comprises, user-user communication of taste, by means of a network computer or taste-device. Another application is employing a network computer for scalable PERFORMANCE of taste with means of taste-devices. An application example of a said network TASTECOM, is for performance of taste to a distributor, retailer, or consumer in advertising, marketing, or sale of a product comprising of a flavor of taste. A further application is in sampling a product comprising of a flavor of taste, from a variety of beer from a brewer. The said applications by means comprising of a network, presents a one-stop-shop location with a simple, convenient, economical, and centralized forum for sampling, testing, selecting, or procuring, of a product comprising a flavor of taste.

The said examples explain the barebones utility, use, and applications of TASTECOM, overlapping in the purpose of use or application by means of, a network computer machine-device with means comprising of a connection to a taste-device, or a taste-device with means comprising for a connection to a said machine-device.

### (3) Phone:

A phone machine-device, as defined herein, is a phone comprising a connection to a phone, hybrid, or other network. A said phone employs a TASTECOM system or process, for performance of taste, with means comprising of a connection to a taste-device. A said TASTECOM on a phone machine-device has use, and applications, comprising for personal, informational, social, and professional purposes.

A phone machine-device performance of taste comprises, on a usage of said phone, or programming said phone with means of a clock therein. A said phone with means of a clock comprises being used similar to an alarm clock, for a time-based PERFORMANCE of taste with means of a taste-device.

A TASTECOM system or process by means of a phone machine-device, comprises a feature for performance of taste comprising on, any incoming call; or an incoming call from a particular phone or phone-group, as identified with means of a caller-id feature on, or connected to, said phone. Another feature of said TASTECOM, is where a phone machine-device comprises performance of taste on a specific usage of said phone, comprising, when a user, initiates a call to; listens to a voice message from; or receives a call from; another user, client, user-client, or machine-device.

The said examples explain the utility, use, and applications of TASTECOM, overlapping in the purpose of use or application by means of, a phone machine-device with means comprising of a connection to a taste-device, or a taste-device with means comprising for a connection to a said machine-device.

### (4) MOBILE TASTEDEV:

A “MOBILE TASTEDEV” is a mobile personal taste-device. The said taste-device comprises user-controls for operation thereof. The said controls are operated by means comprising instant user control, manual or electronic programming, or a hybrid of the aforesaid. The embodiment of said taste-device comprises manual, mechanical, electro-mechanical, or electrical, user-controls. A TASTECOM system or process for PERFORMANCE of taste by means of a MOBILE TASTEDEV, is independent of any other machine, apparatus, or device; with the exception of, a MOBILE TASTEDEV program download from, or upload into, a machine-device or taste-device, or PERFORMANCE of taste with means of a connection from a machine-device or taste-device.

The operation of said MOBILE TASTEDEV is controlled by a user or client, with means comprising user-controls embodying said device. The said MOBILE TASTEDEV comprises user-controls for operation, and means comprising for a connection to a machine-device for operation or co-operation. The activation, deactivation, event-based operation, and PERFORMANCE, of said device is facilitated with means comprising of said user-controls thereon. The said user-controls comprise functional, and/or PERFORMANCE, means for the said device.

A MOBILE TASTEDEV use comprises while a user is on travel and/or mobile. The said device is capable of PERFORMING of taste, comprising while in user possession. The said device is further capable of being carried in a hand bag, placed in a room, or ported into a transport mobile. An operational example of a MOBILE TASTEDEV, comprises, activation of said device while gaming, reading, or watching a sporting event, and deactivation thereof at a time of choice to the user or client. A MOBILE TASTEDEV is an efficient, convenient, and a mobile-friendly device.

The new or enhanced TASTECOM system or process, by means of, a standalone or network computer, a phone, and/or a taste-device, is facilitated for performance of taste by means of a said machine-device and/or taste-device. The utility, use, and applications, of TASTECOM comprise personal, informational, social, and professional, by means of a said machine-device and/or taste-device. The aforesaid utility, use, and applications, are a barebones explanation and are however, not a limitation of TASTECOM by means of a machine-device and/or taste-device.

### BRIEF DESCRIPTION OF THE DRAWINGS

The objectives of this invention will become more apparent, and the invention best understood from the following description of TASTECOM, when read in reference to the accompanying drawings, wherein:

FIG. 1 illustrates a standalone computer with means of a connection to a TASTEDEV.

FIG. 2 illustrates a system diagram of FIG. 1, for PERFORMANCE of taste.

FIG. 3 illustrates a one-way TASTECOM, by means of a computer communication network.

FIG. 4 illustrates a two-way TASTECOM, by means of a communication network.

FIG. 5 illustrates a network computer with means of a connection to multiple TASTEDEVs.

FIG. 6 illustrates a TASTEDEV with an external TASTECNTRLR.

FIG. 7 illustrates a TASTEDEV with an integrated TASTECNTRLR.

FIG. 8 illustrates a wireless TASTEDEV in connection to a device or appliance.

FIG. 9 illustrates a TASTEDEV with means of a single ingredient, or taste-source cylinder.

FIG. 10 illustrates a TASTEDEV with means of multiple ingredients, or taste-source cylinders.

FIG. 11 illustrates a MOBILE TASTEDEV with mechanical user-controls.

FIG. 12 illustrates a MOBILE TASTEDEV with electro-mechanical user-controls.

FIG. 13 illustrates a MOBILE TASTEDEV with electronic user-controls.

### DESCRIPTION OF THE SYSTEM OR PROCESS

This invention pertains to the communication, and creation, of taste. The word “communication” as defined herein, comprises, forward or reverse user-machine, user-client, or user-user, communication within scope of this invention. The said word communication further comprises, forward or reverse machine-client, or machine-machine, communication.

A user-machine communication comprises, when a user interacts with a machine-device, or taste-device. A user-client communication comprises, when a user interacts with a client program, application, service, or platform, in, or by means of, a machine-device or taste-device. A user-user communication comprises, when a user, client, user-client, or host, interacts with another user, client, user-client, or host, by means of, a machine-device with means comprising of a connection to a taste-device, or a taste-device with means comprising for a connection to a machine-device, by means comprising of a network. A user-user communication therein comprises between, a computer user and another computer user, a phone user and another phone user, a computer user and a phone user, or vise-versa, and further between a taste-device user and another taste-device user by means comprising of a network.

A machine-client communication comprises, when a machine-device or taste-device communicates, with a client operating system, program, application, service, or platform, or vice versa. A machine-machine communication comprises when a machine-device communicates, with another machine-device or a taste-device, or internally therewithin; further comprising when a taste-device communicates, with a machine-device or another taste-device, or internally therewithin.

The word “creation” as defined herein, is PERFORMING a mixture, or an output, of taste, with means of, by means of, on, or from, a taste-device, within scope of this invention. The said word creation comprises, creating an output of taste with means of a TASTEDEV, by means of mixing a single ingredient, or multiple ingredients; or performing an output of taste, by means of a single or multiple cylinder taste-source.

A TASTECOM system or process, comprises, performance of taste by means of, a computer or phone machine-device with means comprising of a connection to a taste-device, or a taste-device with mean comprising for a connection to a machine-device or taste-device. A said machine-device employs a TASTECOM system or process to communicate taste information to another user, client, user-client, host, machine-device, or taste-device.

Taste information in a machine-device comprises for performing communication to a taste-device, with means comprising of a taste-device driver that is pre-, device plug-in-, or remotely, installed into said machine-device. The said TASTECOM, when a TASTECNTRLR is present, in the connection between said machine-device and taste-device, or integrated on said taste-device, communicates taste information to said TASTECNTRLR instead, with means comprising of a device driver. The said communicated taste information, is processed by means of the said TASTECNTRLR with control settings thereon, and thereof communicated to the taste-device for PERFORMANCE of taste.

In an enhanced TASTECOM, a TASTECNTRLR comprises regulating creation of smoke on a taste-device. The word ‘taste’, is replaceable or combinable with ‘smoke’ on a TASTECOM, when said ‘smoke’ is associated with a flavor of taste.

In an enhanced TASTECOM system or process, the TASTECNTRLR comprises regulating heat of, or from, a TASTEDEV. A further functionality of a TASTECNTRLR comprises regulating motion of, or on, a TASTEDEV. The said enhanced TASTEDEV performs a combination comprising of taste, heat, and/or motion, therefrom.

The analogy of a TASTECOM system or process, is the communication and/or play of voice or audio, by means of a computer or phone machine-device with means comprising of a connection to a speaker and/or microphone. A further analogy, comprising, performing communication is sending of a fax by means of a computer, phone, hybrid, or other network; and performing creation is printing of a document with means of a computer printer.

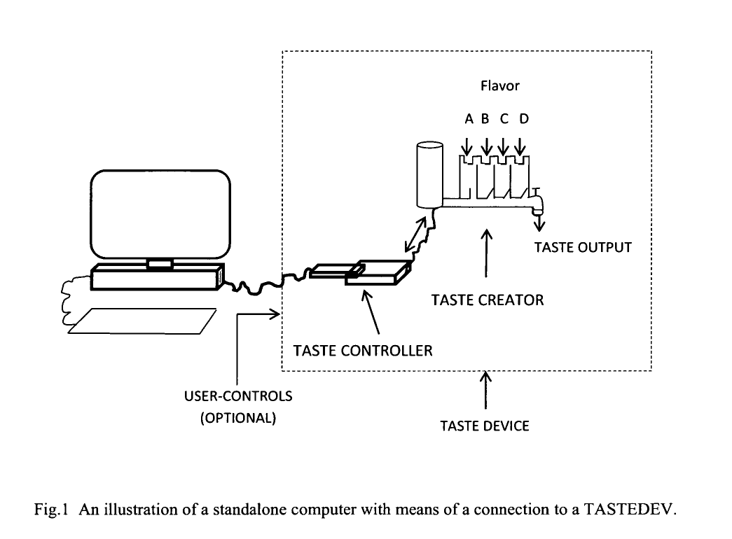

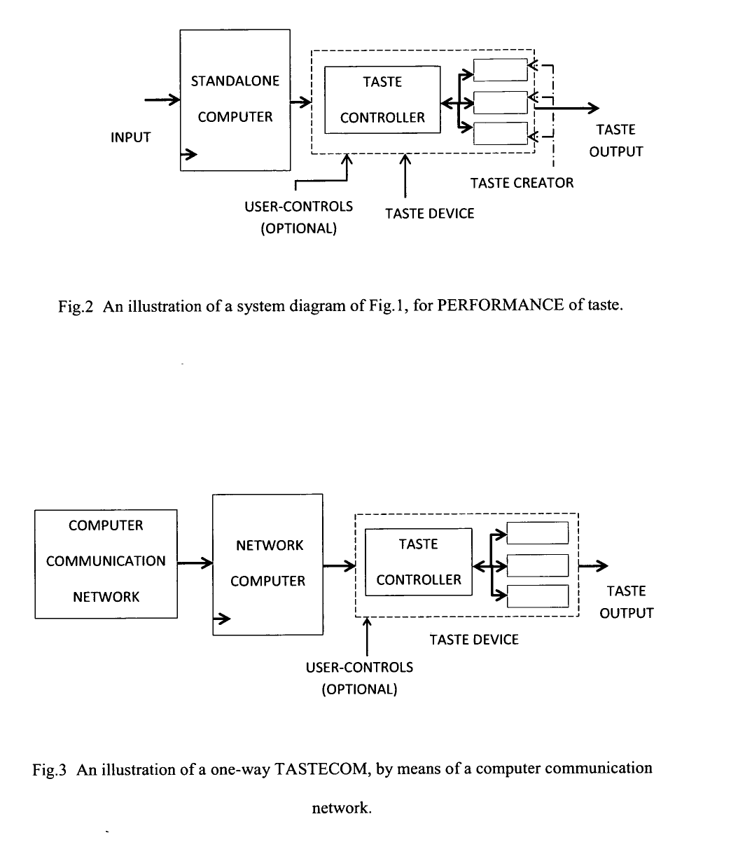

FIG. 1 illustrates a standalone computer machine-device with means of a connection to a TASTEDEV. The said figure shows presence of an optional TASTECNTRLR, in the connection between said standalone computer and TASTEDEV. The said TASTEDEV comprises PERFORMANCE of taste, upon communication of taste information from said standalone computer to said TASTECNTRLR, with means comprising of a device driver. A TASTEDEV comprises manual user-controls, comprising for co-operation. For purposes of this specification, and drawings, a “TASTEDEV” is replaceable with a “taste-device”.

FIG. 2 illustrates a TASTECOM system or process diagram of FIG. 1. The said diagram shows TASTECOM for PERFORMANCE of taste, by means of a standalone computer machine-device with means of a connection to a TASTEDEV, with presence of an optional TASTECNTRLR in said connection. A said TASTECNTRLR alternatively comprises controls for performance with means comprising of a connection to a smoke taste-device.

Having illustrated TASTECOM by means of a standalone computer machine-device, the illustrations present the said for a network computer machine-device. FIG. 3 illustrates a TASTECOM system or process for a one-way communication of taste information, by means of a computer communication network. Here, a network computer machine-device transmits or receives taste information from a user, client, user-client, host, machine-device, or taste-device, with means comprising of a network communication channel by means comprising of a computer network. A said TASTECOM by means of a network computer machine-device, is similar to a TASTECOM by means of a standalone computer machine-device, with the additional capability to perform a one-way TASTECOM by means comprising of a computer network. The said computer communication network may, instead, be a phone, hybrid, or other, communication network for facilitating a said one-way TASTECOM.

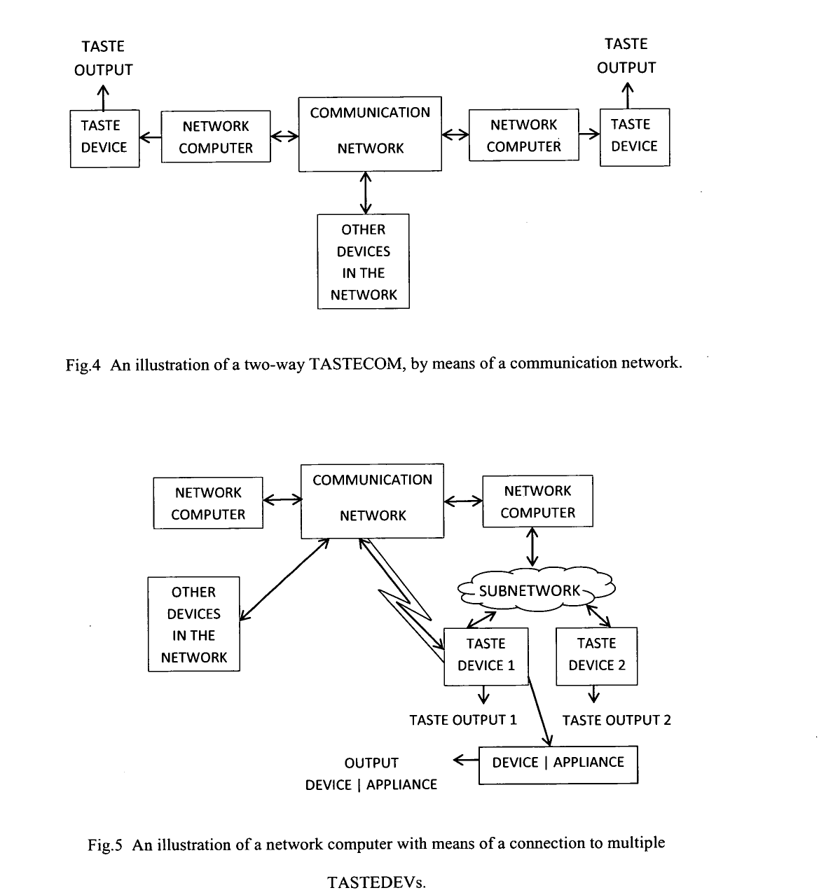

FIG. 4 illustrates a TASTECOM system or process for a two-way communication of taste information, by means comprising of a communication network. Here a communication system or process is capable of two-way communication of taste information, by means comprising of a network. A said two-way communication of taste is employed by means comprising of, receiving taste information from, and/or transmitting taste information to, a user, client, user-client, host, machine-device, or taste-device, by means comprising of a communication network. A said communication network comprises a computer, phone, hybrid, or other network.

A network communication system, comprises, machine-devices, electronic communication devices, and/or a taste-devices, in said network. A said network further comprises means of a connection to a sub-network. A said sub-network comprises a Personal Area Network (“PAN”), or other sub-network, in said network. The said figure shows network electronic devices comprising of, computer or phone machine-devices, wireless communication devices, and taste-devices, in the network.

FIG. 5 illustrates a TASTECOM system or process for PERFORMANCE of taste, with means of a connection, or connections, to multiple TASTEDEVs. The said may be facilitated for independent, or coordinated, PERFORMANCE of taste by means comprising of a network or sub-network. A network machine-device communicates, with another machine-device, or to a taste-device, comprising said network or sub-network, with means comprising of a network communication channel by means comprising of a network. The said network comprises a Local Area Network (“LAN”), a Personal Area Network (“PAN”), or other network, for performance of taste with means comprising of a network taste-device. The said figure shows a network computer with means of a connection, or connections, to a sub-network comprising TASTEDEV1, and TASTEDEV2. The said figure also shows TASTEDEV1 comprising a direct wireless connection to said network.

A network computer communicates taste information to a network taste-device, with means comprising of a network device driver. The said network computer comprises capability of communicating taste information for independent, or coordinated, PERFORMANCE of taste with means comprising of a connection, or connections, to network taste-devices in said multi taste-device network.

A network computer machine-device with means comprising of a connection, or connections, to multiple taste-devices, is similar to a network computer machine-device with means comprising of a connection, or connections, to multiple speakers, where a said speaker is, or speakers are, performance playable either independently, or in coordination. A further similarity exists, in the case of a network computer machine-device with means comprising of a connection, or connections, to multiple network printers, with means to pre-assign, or assign, a print job.

The performing communication of taste by means of a network is further employed, by means comprising of a remote network computer machine-device. A said remote network computer comprises PERFORMANCE of taste, directly, with means of a connection to a network taste-device, by means of a network.

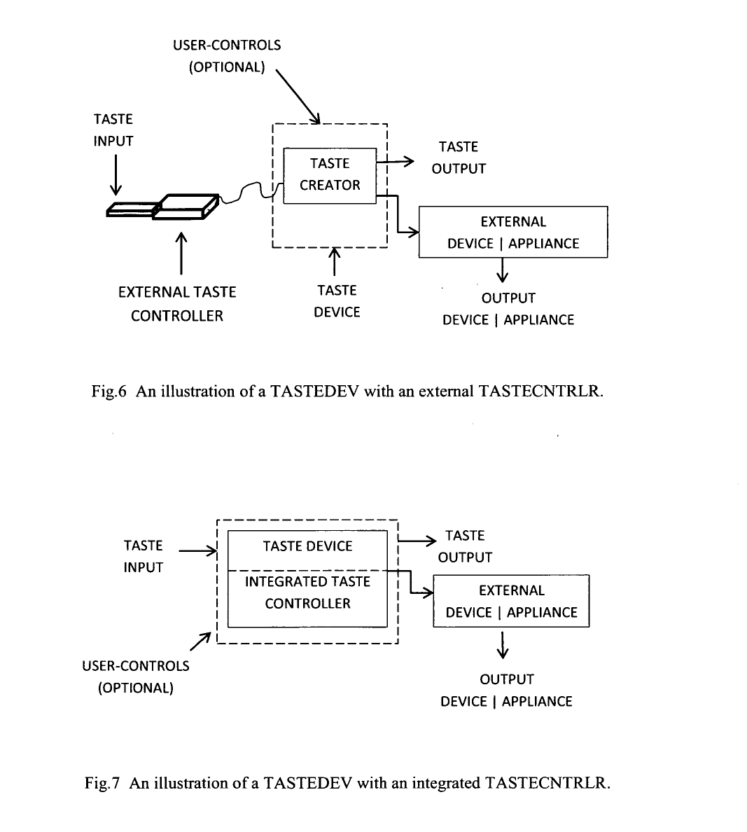

FIG. 6 illustrates a more detailed view of an external taste controller with means of a connection to a TASTEDEV. Here, a machine-device connects to a TASTEDEV, with presence of said external TASTECNTRLR in the connection between said machine-device and TASTEDEV. A said machine-device communicates taste information to said external TASTECNTRLR, with means comprising of a device driver. The said communicated taste information is processed with means comprising of control settings on said TASTECNTRLR, and communicated to said TASTEDEV for PERFORMANCE of taste. The said figure also shows said TASTEDEV in connection to a device or appliance. The said device or appliance, utilizes the taste output from said TASTEDEV, comprising for performing said device or appliance specific operations. The said TASTEDEV connected, device specific operation comprises of an output of a solid, quasi-liquid, or liquid taste substance; and appliance specific operation comprises creation of a beverage, food, or the like.

FIG. 7 illustrates a TASTEDEV with an integrated TASTECNTRLR. The said integration follows technology trends in integrating parts, components, and subsystems, to make a system or process more efficient. The figure shows said TASTEDEV with a port connector, for connecting said TASTEDEV to a machine-device, another taste-device, or a power source.

FIG. 8 illustrates a wireless TASTEDEV. A wireless TASTEDEV consists of a wireless antenna-, -receiver for receiving, or -transceiver for communicating, comprising of taste information. A wireless TASTEDEV with a transceiver comprises command, control, communication, and/or coordination, by means of a machine-device and/or a taste-device. A machine-device or taste-device communicates taste information to a wireless TASTEDEV, with means comprising of a wireless device driver, for PERFORMANCE of taste. The said figure illustrates said wireless TASTEDEV in connection to a device or appliance, namely, DEVICE1 or APPLIANCE1, and DEVICE2 or APPLIANCE2. The said TASTEDEV communicates with a said device or appliance with means wireline or wireless. The performance of taste from said TASTEDEV is output to a said device or appliance, comprising by means of, pre-programmed, programmed, or command based, networked communication.

An enhanced TASTECOM comprises a machine-device or taste-device communication of taste information, for PERFORMANCE on a wireless TASTEDEV, by means comprising of a network. Another enhanced TASTECOM, comprises, a network taste-device communication between, and/or coordinated PERFORMANCE of taste on or from, a said other.

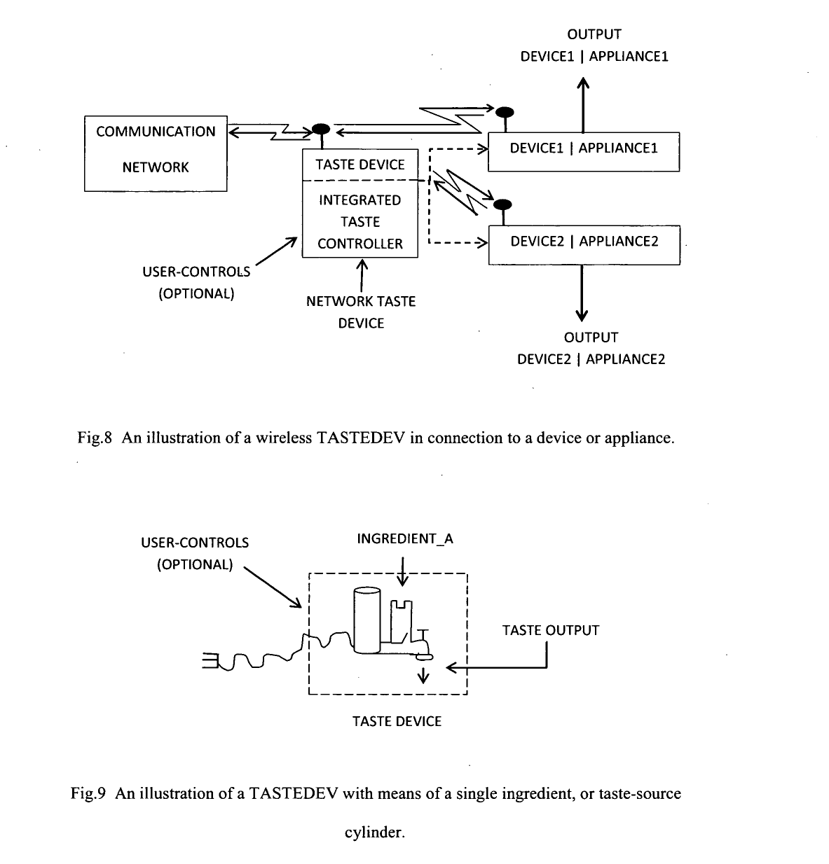

FIG. 9 illustrates a TASTEDEV, for performing creation of a single flavor of taste. The said figure shows a TASTEDEV for output of a single flavor of taste, by means comprising of a flavor of taste created with means of ingredient_A from, or an output of a taste substance from a single cylinder of, a taste-source. The said TASTEDEV is shown with a machine-device port connector, and a control tap for outputting of taste.

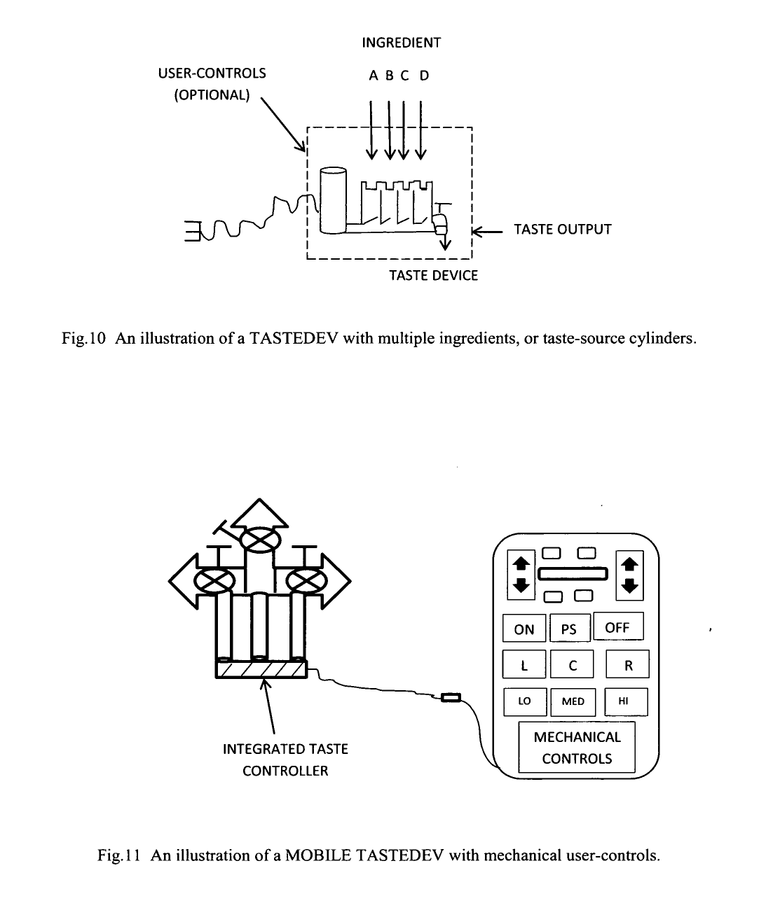

FIG. 10 illustrates a TASTEDEV for PERFORMANCE of a flavor, from multiple flavors, of taste. A machine-device communicates taste information to said TASTEDEV comprising for PERFORMANCE of a flavor, from multiple flavors, of taste on or from said device. The said figure illustrates a TASTEDEV, for PERFORMANCE of a taste with means comprising of, multiple ingredients or substances, or multiple taste-source cylinders. The said figure shows a TASTEDEV output created by means comprising of, a combination of ingredients or taste substances A, B, C, and D from multiple cylinders of a taste-source.

The said illustrations presented, and explained, performance of taste with means of a TASTECOM system or process, by means of, a machine-device with means comprising of a connection to a taste-device, and a taste-device with means comprising for a connection to a machine-device or taste-device.

A TASTECOM system or process is employed, with means comprising of an operating system, program, application, service, or platform. A TASTECOM for performance of taste, by means of a machine-device with means comprising of a connection to a taste-device, is similar to communication and/or play of voice or audio, by means of a machine-device with means comprising of a connection to a speaker and/or a microphone. A TASTECOM for performing communication of taste information is similar to: communication of voice or audio by means of a computer or phone machine-device; or communication of text with means of an e-mail program, application, service, or platform; both the said by means comprising of a network, comprising of the intemet. The said communication comprises communicating a pre-defined, programmed, or INPUT, taste information, between a user, client, user-client, host, machine-device, or taste-device, and another user, client, user-client, host, machine-device, or taste-device, by means comprising of a network.

A taste-device receives the necessary operational power, with means of a connection to a power supply. The said power supply is facilitated, with means comprising of a machine-device power source connection to a taste-device. A said power supply may alternatively be facilitated with means of a power source comprising a battery, plugging said device into an electrical power outlet comprising for recharging, or sharing a power source.

### MOBILE TASTEDEV

A MOBILE TASTEDEV is a mobile personal taste-device. The said device is functionally efficient for PERFORMANCE of taste, while in possession of a user. The features of a MOBILE TASTEDEV, comprise, a lightweight embodiment for user possession, and user-controls for operation, thereof.

A TASTECOM system or process for PERFORMANCE of taste, by means of a MOBILE TASTEDEV, is somewhat similar to that of a machine-device with means of a connection to a taste-device. However, a MOBILE TASTEDEV is an independent device in embodiment, comprising operation. The said device comprises user-controls that are manual and/or programmable. The PERFORMANCE of taste on, or from, a MOBILE TASTEDEV is controlled by the user whom, or the client which, with means of said controls selects or sets control subjecting operation of the said device. The said device comprises manual, mechanical, electro-mechanical, and/or electrical user-controls, comprising an optional feature for programmability.

FIG. 11 illustrates a MOBILE TASTEDEV comprising mechanical user-controls. The said device is operated by means comprising said mechanical, and/or manual, controls on said device, for activation, deactivation, or PERFORMANCE, of taste thereon or therefrom. A user operation on user-controls on the device-controller console effects PERFORMANCE of taste on said device. The said figure shows mechanical controls, named ON, OFF, and PS, for switching the said device on, off, and for pausing. The controls comprising for activating the left, center, or right, faucets are shown with control switches named L, C, and R, whereby a user or client effects operation of a single faucet, or a combination thereof. The said figure shows an embodiment with mechanical controls, for adjusting, the rate of creation, or the strength, of taste, from said device. The arrows on the top left, and right, of the said device controller, show mechanical controls for increasing, or decreasing, the rate of creation of taste. The said figure also shows mechanical control switches LO, MED, and HI, corresponding respectively to low, med, and hi, strength of taste for PERFORMANCE. The said device controller communicates user-control input to said MOBILE TASTEDEV, comprising for PERFORMING taste, heat, and/or motion, on or from said device.

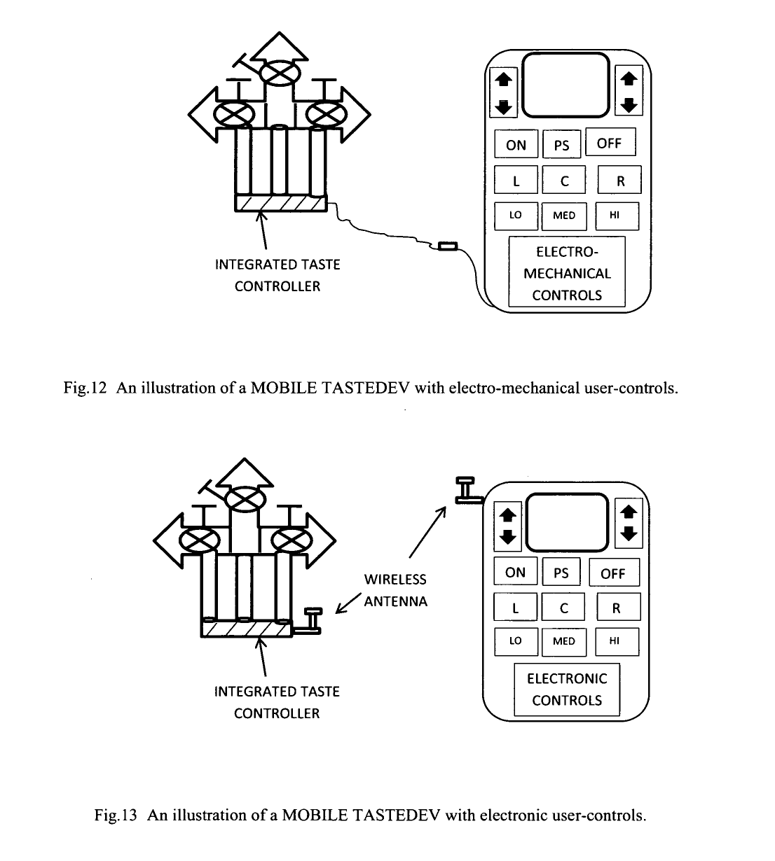

FIG. 12 illustrates a MOBILE TASTEDEV consisting electro-mechanical user-controls. The said device is operated by means comprising said electrical, mechanical, or electro-mechanical, and/or manual, controls on the said device, for activation, deactivation, or PERFORMANCE, of taste thereon or therefrom. The said figure shows a device controller console similar to that of FIG. 11, the contrast being electro-mechanical, instead of mechanical only, user-controls on the said device controller of FIG. 12.

The said figure shows an optional display screen, adjacently between said electro-mechanical controls, for monitoring PERFORMANCE of said device, comprising during operation. The said display on said device, comprises operational information on, the amount of taste or time remaining on; the rate of creation or the strength of taste on or from; and/or the amount of power on; the said device. The said display monitoring of performance, may be facilitated on any taste-device, similar to that for a MOBILE TASTEDEV as explained herein preceding.

FIG. 13 illustrates a MOBILE TASTEDEV consisting electrical, comprising electronic, user-controls. The said device is operated by means comprising said electrical comprising electronic, and/or manual, controls on said device, for activation, deactivation, or PERFORMANCE, of taste thereon or therefrom. The said figure shows a device controller console similar to that of FIG. 12, the contrast being electrical comprising electronic, instead of electro-mechanical, user-controls on the said device controller of FIG. 13.

A MOBILE TASTEDEV receives the necessary operational power, with means of a connection to a power supply. The said power supply is facilitated with means of a power source comprising a battery, plugging said device into an electrical power outlet comprising for recharging, or sharing a power source.

The illustrations presented herein are however, not a limitation of a TASTECOM, nor a taste-device, wherein the specification comprises all designs, and embodiments, within scope of this invention.

### Taste Data Communication:

The system or process for communication of taste, with means comprising of a network communication channel by means comprising of a network, in the absence of a network communication protocol, or standard, for the said communication of taste information, is facilitated by means comprising of “taste data communication”. The said taste data communication comprises receiving and/or transmitting, comprising “taste communication data”, by means comprising of a network. A TASTECOM system or process, for communication of taste by means comprising of a network, is presented herein-following:

### Transmit:

A network user, client, user-client, host, machine-device, or taste-device, transmits taste information to another user, client, user-client, host, machine-device, or taste-device, with means comprising of a network communication channel by means comprising of a network.

A network TASTECOM utilizes pre-defined, programmed, or INPUT, taste information in said transmitting communication. The said taste information is processed before, or during, transmitting communication, with means comprising of data mapping the said taste information into “taste communication data”. The said forward transformed “taste communication data” is thereupon transmitted, by means comprising of a network.

### Receive:

A network user, client, user-client, host, machine-device, or taste-device, receives taste information from a user, client, user-client, host, machine-device, or taste-device, with means comprising of a network communication channel by means comprising of a network.

The said received taste information is processed during, or after, receiving “taste communication data”, with means comprising of reverse data mapping the said “taste communication data” into the reverse transformed, communicated taste information. The said transmitted and network machine-device, or taste-device, received taste information is thereupon utilized by TASTECOM, for performance of taste.

### Communication and Processing:

Network communication of taste information, comprises, (1) transmitting “taste communication data” to, or (2) receiving “taste communication data” from, a user, client, user-client, host, machine-device, or taste-device, by means comprising of a network. The said taste information comprises being utilized for performance of taste on a machine-device, or taste-device. The said performance comprises processing comprising customization, storing, and/or communicating, of taste information, for performance with means comprising of a network or non-network operating system, program, application, service, or platform, on a machine-device or taste-device. The said taste information may be assigned a null, comprising, during TASTECOM processing, storing, and/or communicating, of taste information for performance on a machine-device, or taste-device.

Herein-following is a summary of a TASTECOM system or process, by means of, a standalone or network computer, a phone, and a MOBILE TASTEDEV.

### (1) Standalone Computer:

A standalone computer machine-device receives taste information, with means comprising of an INPUT. The said received taste information is employed, with means comprising of an operating system, program, application, service, or platform, on said standalone computer for performance of taste.

A standalone computer machine-device comprises a wireline or wireless connection to a taste-device. The said standalone computer communicates taste information with means of a connection to a taste-device, for PERFORMANCE of taste therefrom.

A TASTECOM system or process by means of, a standalone computer machine-device with means comprising of a connection to a taste-device, or a taste-device with means comprising for a connection to a standalone computer, presents for processing, storing, and/or communicating, of taste information for performance of taste.

### (2) Network Computer:

A network computer machine-device receives taste information, with means comprising of an INPUT, by means comprising of a network. A said network computer comprises employing the means of a network, comprising of the internet, for performance of taste.

A network computer comprises, receiving taste information from, and/or transmitting taste information to, a user, client, user-client, host, machine-device, or taste-device, by means comprising of a network. A network computer communicated taste information, is thereupon processed, stored, and/or communicated, for performance with means comprising of a user, client, user-client, host, machine-device, or taste-device's operating system, program, application, service, or platform.

A said network computer communicates taste information with means of a wireline or wireless connection to a taste-device, for PERFORMANCE of taste. The performance of taste, by means of a network computer machine-device with means comprising of a connection to a taste-device, is similar to the PERFORMANCE of taste, by means of a standalone computer machine-device with means comprising of a connection to a taste-device, with the additional capability of said network computer for performance of taste to, or from, a user, client, user-client, host, machine-device, or taste-device, by means comprising of a network.

An enhancement of a TASTECOM system or process, by means of a network computer machine-device, is enablement of asynchronous and/or real-time performance of taste, by means comprising of a computer, hybrid, or other network. The said enhancement of TASTECOM by means of a network computer, comprises, receiving and/or transmitting taste information during communication between a user, client, user-client, host, machine-device, or taste-device, and another user, client, user-client, host, machine-device, or taste-device, comprising in one-, two-, and/or multi-way communication by means comprising of a network.

A TASTECOM system or process by means of, a network computer machine-device with means comprising of a connection to a taste-device, or a taste-device with means comprising for a connection to a network computer, presents for processing, storing, and/or communicating, of taste information for performance of taste.

### (3) Phone:

A phone machine-device comprises a wireline or wireless connection to a taste-device for PERFORMANCE of taste. The said connection is similar to, a phone machine-device connection to an external caller-id device or DSL router, or a computer machine-device connection to a taste-device.

A phone machine-device communicates taste information to a taste-device, either, directly; or indirectly with means of a TASTECNTRLR, in the connection between said phone and taste-device, or integrated on said taste-device; for PERFORMANCE of taste.

An enhancement of TASTECOM by means of a phone machine-device, is enablement of asynchronous and/or real-time performance of taste, by means of comprising of a phone, hybrid, or other network. The said enhancement of TASTECOM by means of said phone, comprises, receiving and/or transmitting taste information, during communication between a user, client, user-client, or host, and another user, client, user-client, or host, comprising in one-, two-, and/or multi-way communication by means comprising of a network.

A TASTECOM system or process by means of, a phone machine-device with means comprising of a connection to a taste-device, or a taste-device with means comprising for a connection to a phone, presents for processing, storing, and/or communicating, of taste information for performance of taste.

### (4) MOBILE TASTEDEV:

A MOBILE TASTEDEV is a unique taste-device, in that, the PERFORMANCE of taste thereon, or therefrom, is independent of any other device, apparatus, or machine.

A user activates a MOBILE TASTEDEV comprising manually, for PERFORMANCE of taste. A user operates a MOBILE TASTEDEV, with means comprising of user-controls embodying said device. A said taste-device PERFORMANCE of taste, comprises, on a user setting or selection of user-controls on said device. A said MOBILE TASTEDEV comprises of an optional TASTECNTRLR, for regulating PERFORMANCE of taste on or from said device.

A said MOBILE TASTEDEV comprises an enhanced feature, for user or client programmability for PERFORMANCE of taste. A said MOBILE TASTEDEV may be enhanced to perform similar to a TASTEDEV, for a machine-device performance of taste with means of a connection thereto.

A TASTECOM system or process by means of, a MOBILE TASTEDEV, or a MOBILE TASTEDEV with means comprising for a connection to a machine-device, presents for processing, storing, and/or communicating, of taste information for performance. The said TASTECOM by means of a MOBILE TASTEDEV has numerous personal, social, professional, consumer, and business use, and applications.

### Enhancements on a Taste-Device:

The additional or enhanced features for a taste-device, comprises: (1) user- or client-controls for manual and/or programmable setting or selecting of, a rate of creation, or a strength, of taste on or from a taste-device; (2) capability for PERFORMING communication to a machine-device, another taste-device, and/or an appliance, of a manual and/or programmable user- or client-control setting, selection, or input, on or into a taste-device; (3) user-controls for setting, selecting, or input, of a flavor, from multiple flavors, of taste for PERFORMANCE by means of, with means of, on, or from, a taste-device; (4) capability for PERFORMANCE of multiple favors of taste by means of, with means of, on, or from, a taste-device; facilitated by means of loading thereinto, one taste-source comprising of multiple flavors of taste, or multiple taste-sources, for performance of taste; (5) reuse of a taste-device by means comprising refilling, re-supplying, or changing, the taste-source comprising of a taste ingredient or substance comprising of flavor of taste comprising sweet, sour, bitter, salty, or a variation thereof; a procedure which is similar to, refilling milk, water, or sugar, or changing of an accessory, part, or component, similar to a coffee filter; (6) functional or operational timing for activation, deactivation, and/or interval of use, of a taste-device; (7) performing of taste comprising heat and/or motion on, of, or from, said taste-device; and/or (8) supplying power to a taste-device with a renewable energy source.

An enhancement of a TASTECOM system or process of this invention comprises, embedding a taste-device onto or into a machine-device, and sensing of taste with means of a taste sensor. A said embedded taste-device, or a taste sensor, comprises being utilized with TASTECOM for performance of taste.

An enhancement on a taste-device, comprises, enablement of user or client programmability thereon. Another enhancement on a taste-device, comprises, enablement of time-based, operation thereof, or functionalities thereon or therefor. A further enhancement comprises a mobile or non-mobile taste-device for a transport mobile.

### Enhancements on TASTECOM:

A network TASTECOM system or process enhances network communication, by means of a network machine-device or taste-device, by presenting to a user, client, user-client, host, machine-device, or taste-device, the additional element of taste in said network communication. A said network TASTECOM requires enhancements, comprising, in a network operating system, program, application, service, and/or platform, for facilitating said network taste communication.

A further enhancement of TASTECOM is in communicating taste information, by means of a taste-device, to a machine-device or another taste-device, by means comprising of a network. The said TASTECOM is an enhanced system or process for INPUT of taste information to a machine-device, or another taste-device, for performance of taste.

A further enhancement of TASTECOM is a machine-device connectable portable, comprising mobile, TASTEDEV, referred to herein as “PM-TASTEDEV”. A PM-TASTEDEV is a portable, comprising mobile, embodiment of a TASTEDEV.

A machine-device communicates taste information to a PM-TASTEDEV, with means of a connection thereto, with means comprising of a device driver. The performance of taste by means of a PM-TASTEDEV with means comprising of, or for, a connection to a machine-device or taste-device, is similar to the performance of taste by means of a TASTEDEV with means comprising of, or for, a connection to a machine-device or taste-device. The said PM-TASTEDEV is suitable for wireline or wireless use with a portable, comprising mobile, machine-device.

Another enhancement of TASTECOM is a pre-programmed or programmable taste-device, referred to herein as “E-TASTEDEV”. The said E-TASTEDEV is a permanent, desktop, stationary, or portable, embodiment of a MOBILE TASTEDEV.

An E-TASTEDEV comprises user or client programmability of taste information for PERFORMANCE. The PERFORMANCE of taste by means of an E-TASTEDEV with means comprising of, or for, a connection to a machine-device or taste-device, is similar to the PERFORMANCE of taste by means of a MOBILE TASTEDEV with means comprising of, or for, a connection to a machine-device or taste-device. An enhancement of an E-TASTEDEV comprises network adaptability for independent, or coordinated, PERFORMANCE of taste, by means comprising of a network. The E-TASTEDEV comprises indoor or outdoor applications.

The said PM TASTEDEV, and E-TASTEDEV, are classified within the definition of, a TASTEDEV, or a MOBILE TASTEDEV, within scope of this invention.

I claim:

1. A system or process for performance of taste comprising heat and/or motion, by means of, a computer or phone machine-device, or a taste-device.

2. A device, apparatus, or machine, of claim 1, with means for a connection to a computer or phone machine-device, or a taste-device.

3. A device, apparatus, or machine, of the system or process of claim 1, for performance of taste comprising heat and/or motion, named or classified a TASTEDEV.

4. An element, component, or part, of a TASTEDEV of claim 3, for use therein, thereon, or therewith.

5. A TASTEDEV of claim 3, employing the means of a power source, comprising a battery.

6. An operating system, program, application, service, or platform, of claim 1, that enables processing, storing, and/or communicating, of taste comprising heat and/or motion information, for performance of taste comprising heat and/or motion.

7. An operating system, program, application, service, or platform, of claim 1, for asynchronous and/or real-time performance of taste, heat, and/or motion, comprising with a performance output combination comprising of, text, hyperlink, audio, image, and/or moving picture.

8. A system or process for performance of taste comprising heat and/or motion, by means of a user, or client, controlled personal taste-device.

9. A device, apparatus, or machine, of claim 8, with means for a connection to a computer or phone machine-device, or a taste-device.

10. A device, apparatus, or machine, of claim 8, for performance of taste comprising heat and/or motion, named or classified a MOBILE TASTEDEV.

11. An element, component, or part, of a MOBILE TASTEDEV of claim 10, for use therein, thereon, or therewith.

12. A MOBILE TASTEDEV of claim 10, employing the means of a power source, comprising a battery.

13. An operating system, program, application, service, or platform, that enables performance comprising of taste, heat, and/or motion, on a culinary device or appliance, by means comprising of a network.
